(19) United States
(12) Patent Application Publication
(10) Pub. No.: US 2014/0215309 A1
(43) Pub. Date: Jul. 31, 2014

(54) PERMISSION CONTROL SYSTEM AND METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: CHUNG-I LEE, New Taipei (TW); DE-YI XIE, Shenzhen (CN); HAI-YUN CHEN, Shenzhen (CN); AN-SHENG LUO, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/132,860

(22) Filed: Dec. 18, 2013

(30) Foreign Application Priority Data
Jan. 28, 2013 (CN) 2013100310747

(51) Int. Cl. G06F 3/0484; G06F 17/22

(52) U.S. Cl. CPC G06F 3/0484; G06F 17/2247
USPC 715/234

(57) ABSTRACT

A computer searches for a data list from a database and assigns data of a data field of the data list to a graphical user interface (GUI) widget in the webpage. The computer searches for a permission control list from the database and parses configuration information of the permission control list. The computer assigns the data of the one or more data fields of the data list to the configuration information of the permission control list, and amends a status of each GUI widget corresponding to the configuration information.

### BACKGROUND

1. Technical Field

The embodiments of the present disclosure relate to information processing technology, and particularly to a webpage permission control system and method.

2. Description of Related Art

A website may control access privilege for different people. For example, an employee may be restricted from accessing a specific webpage of the Website, and another employee may access the specific webpage of the website without any restriction. However, at present, most website establishes an independent page for each employee with a specific permission, which may result in difficulty of maintaining the website. Therefore, there is room for improvement in the art.

### BRIEF DESCRIPTION OF THE DRAWINGS

FIG. 1 is a block view of one embodiment of a computer including a webpage permission control system.

FIG. 2 is a block diagram of one embodiment of function modules of the webpage permission control system included in the computer in FIG. 1.

FIG. 3 is a flowchart of one embodiment of a webpage permission control method.

FIG. 4 illustrates a permission control list.

FIG. 5 illustrates a data list.

FIG. 6 illustrates a webpage.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable median include CDs, DVDs, BLU-RAY, flash memory, and hard disk drives.

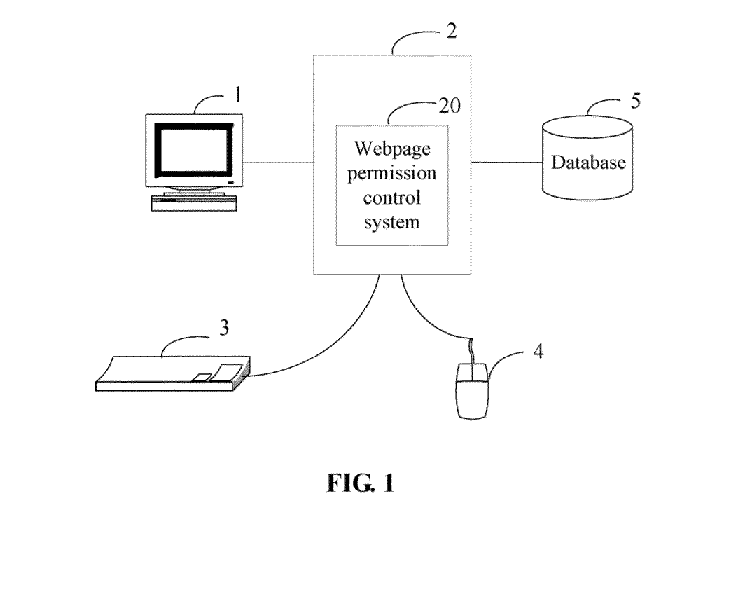

FIG. 1 is a block diagram of one embodiment of a computer 2. The computer 2 includes a webpage permission control system 20. A plurality of peripherals are electronically connected to the computer 2, such as a display device 1, a keyboard 3, and a mouse 4. The peripherals may be used to input or as output for various computer signals or software interfaces. The computer 2 electronically connects to a databases 5 using open database connectivity (ODBC) or JAVA database connectivity (JDBC), for example.

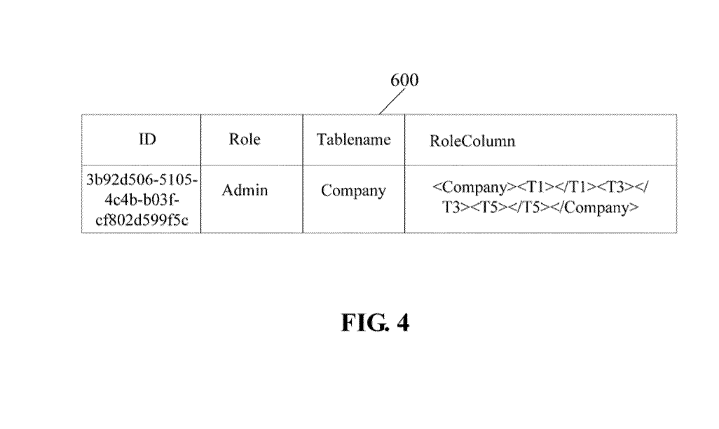

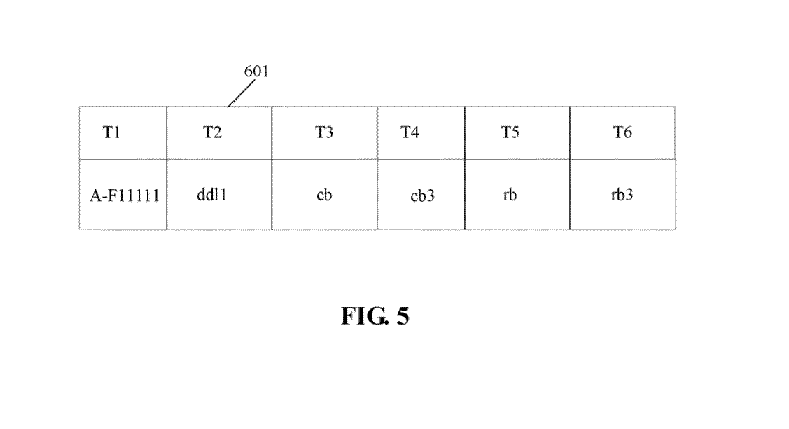

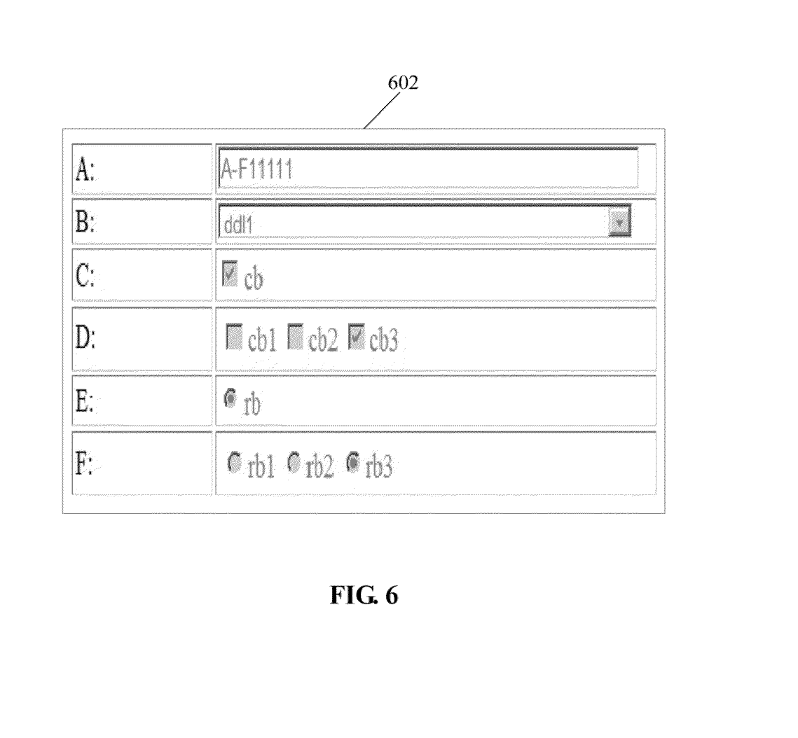

The database 5 may store a permission control list 600 as shown in FIG. 4, a data list 601 as shown in FIG. 5, and a webpage 602 as shown in FIG. 6. The permission control list 600 is a table, and the permission control list 600 includes, but not limited to, four data fields, namely a first data field (e.g., label the first data field using “ID” as shown in FIG. 4), a second data field (e.g., label the second data field using “Role” as shown in FIG. 4), a third data field (e.g., label the third data field using “Tablename” as shown in FIG. 4), and a fourth data field (e.g., label the fourth data field using “Rolecolumn” as shown in FIG. 4).

The first data field of the permission control list 600 is a primary key of the permission control list 600. The first data field of the permission control list 600 may be, but is not limited to, a unique identification number. For example, the unique identification number may be “3b92d506-5105-4c4b-b03f-cf802d599f5c” as shown in FIG. 4.

The second data field of the permission control list 600 determines an authority of a user who accesses the data list 601. If the second data field of the permission control list 600 is associated with a table name of the data list 601, then the user is capable of accessing the data list 601, who is associated with the second data field of the permission control list 600. For example, if the role of the permission control list 600 is associated with five data lists 601, the user who is associated with the second data field is capable of accessing the five data lists 601. As shown in FIG. 4, the second data field “Admin” of the permission control list 600 is associated with the third data field “Company”, the user who is associated with “Admin” is capable of accessing the data list “Company.”

The third data field of the permission control list 600 includes a table name of the data list 601. In other words, the permission control list 600 is associated with the data list 601 using the third data field.

The fourth data field of the permission control list 600 determines an authority for the user to access the data fields of the data list 601. The fourth data field of the permission control list 600 includes names of the data fields of the data list 601. For example, as shown in FIG. 4 to FIG. 5, the fourth data field of the permission control list 600 includes three names of the data fields of the data list 601, namely T1, T3, and T5.

The data list 601 may include, one or more data fields. As shown in FIG. 5, the data list 601 includes six data fields, namely the data field T1, the data field T2, the data field T3, the data field T4, the data field T5, and the data field T6 as shown in FIG. 5. The webpage 602 includes one or more graphical user interface (GUI) widgets as shown in FIG. 6, namely the GUI widget A, the GUI widget B, the GUI widget C, the GUI widget D, the GUI widget E, and the GUI widget F. The GUI widget is an element of the GUI that displays an information arrangement changeable by the user. The GUI widget may be, but is not limited to a button, a text box, a list box, a menu, a combo box or any other widgets. Each data field of the data list 601 corresponds to one GUI widget of the webpage 602. For example, the data field T1 corresponds to the GUI widget A, the data field T2 corresponds to the GUI widget B, the data field T3 corresponds to the GUI widget C, the data field T4 corresponds to the GUI widget D, the data field T5 corresponds to the GUI widget E, the data field T6 corresponds to the GUI widget F. In one embodiment, as shown in FIG. 5-6, the GUI widget A displays data “A-F11111” when the webpage 602 is accessed.

In addition, each GUI widget also includes four statuses, namely a visible status, a written-read status, a read-only status, and an invisible status. The visible status indicates that data in the GUI widget is visible to the user when the webpage 602 is displayed. The written-read status indicates that the data in the GUI widget can be read and/or amended. The read-only status indicates that the data in the GUI widget is restricted to read only. The invisible status indicates that the GUI widget is invisible to the user. The status of each GUI widget is the visible status as default. The user can amend the status of the each GUI widget. For example, the user may amend the status of the GUI widget from the visible status to the read-only status.

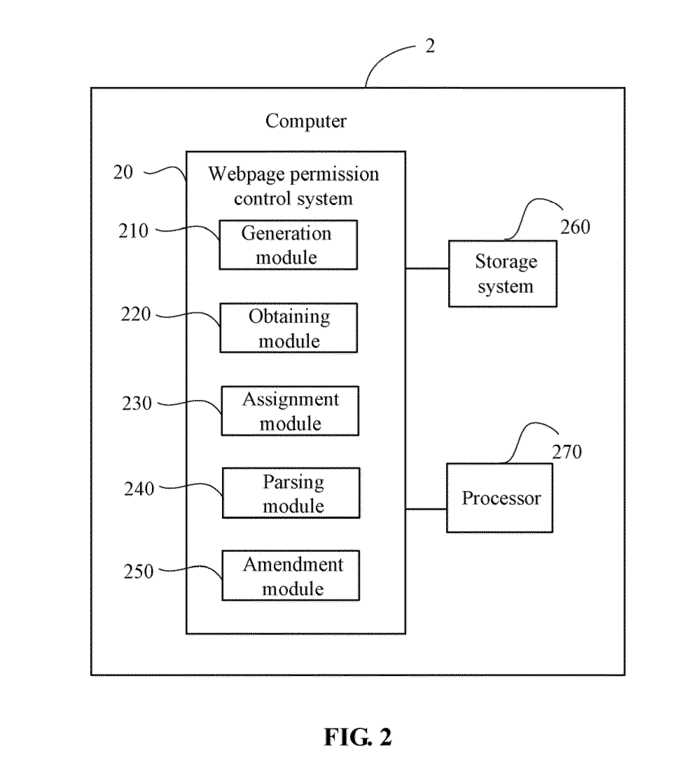

FIG. 2 is a block diagram of one embodiment of function modules of the webpage permission control system 20. In one embodiment, the webpage permission control system 20 includes a generation module 210, an obtaining module 220, an assignment module 230, a parsing module 240, and an amendment module 250. The computer 2 further includes a storage system 260, and at least one processor 270. The modules 210-250 may include computerized code in the form of one or more programs that are stored in the storage system 260. The computerized code includes instructions that are executed by the at least one processor 270 to provide functions for the modules 210-250. The storage system 260 may be a memory, such as an EPROM memory chip, hard disk drive (HDD), or flash memory stick.

The generation module 210 generates the permission control list 600 and saves the permission control list 600 into the database 5.

The obtaining module 220 loads the webpage 602 from the database 5 and obtains a name of each GUI widget in the webpage 602. For example, as shown in FIG. 6, the six names of the GUI widget in the webpage 602 are obtained when the webpage 602 is accessed.

The assignment module 230 searches for the data list 601 from the database 5 and assigns data from the data list 601 to each GUI widget in the webpage 602. In one embodiment, the assignment module 230 assigns the data of each data field of the data list 601 to the GUI widget corresponding to the data field of the data list 601. For example, as shown in FIG. 5-6, the GUI widget A is associated with the data field T1, the GUI widget A is assigned to the data “A-F11111.” The GUI widget A displays data “A-F11111” when the webpage 602 is displayed.

The parsing module 240 searches for the permission control list 600 from the database 5, parses configuration information of the permission control list 600 and assigns the data of one or more data fields of the data list 601 to the configuration information of the permission control list 600. In one embodiment, the configuration information corresponds to one or more data fields of the data list 601 upon the condition that the configuration information includes names of the one or more data fields of the data list 601. The parsing module 240 searches for the fourth data field of the permission control list 600 and obtains configuration information from the fourth data field of the permission control list 600. As shown in FIG. 4, the parsing module 240 searches for the fourth data field using the keyword “RoleColumn” and obtains the configuration information “<Company><T1>A-F11111</T1><T3></T3><T5></T5></Company>.” The configuration information comprises one or more names of the data fields of the data list 601, and the parsing module 240 assigns the data of the data fields of the data list 601 to the configuration information. For example, the parsing module 240 assigns the data of the data fields T1, T3 and T5 to the configuration information, changes the configuration information to “<Company><T1>A-F11111</T1><T3>cb</T3><T5>rb</T5></Company>.”

The amendment module 250 amends a status of each GUI widget corresponding to the configuration information. After amending the status of each GUI widget corresponding to the configuration information, the permission control of the webpage 602 is finished.

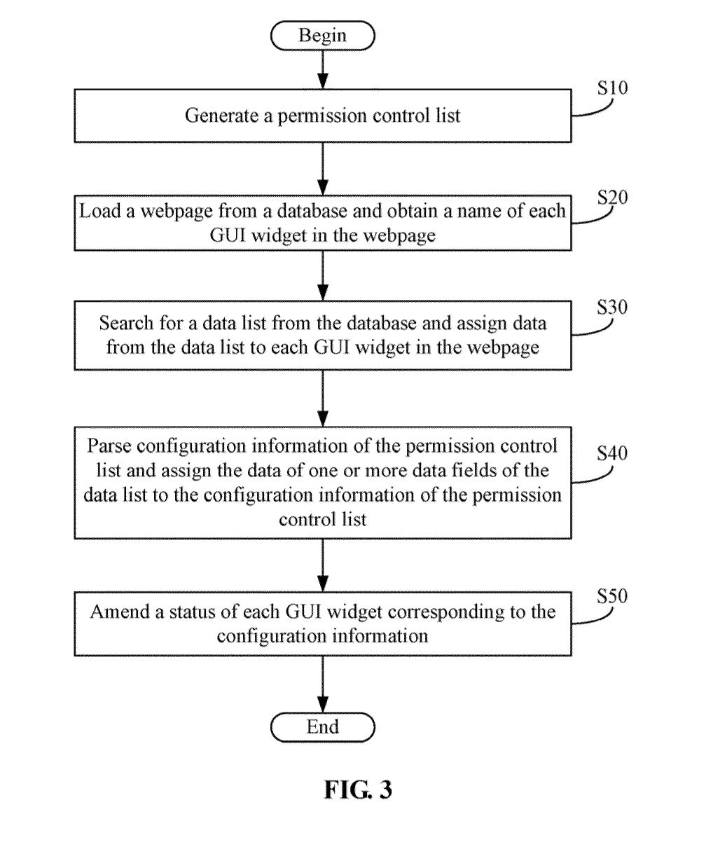

FIG. 3 is a flowchart of one embodiment of a webpage permission control method. Depending on the embodiment, additional steps may be added, others deleted, and the ordering of the steps may be changed.

In step S10, the generation module 210 generates a permission control list 600 and saves the permission control list 600 into the database 5. The permission control list 600 is generated as shown in FIG. 4.

In step S20, the obtaining module 220 loads a webpage 602 from the database 5 and obtains a name of each GUI widget in the webpage 602. For example, as shown in FIG. 6, the six names of the GUI widget in the webpage 602 are obtained when the webpage 602 is accessed.

In step S30, the assignment module 230 searches for a data list 601 from the database 5 and assigns data from the data list 601 to each GUI widget in the webpage 602.

In step S40, the parsing module 240 searches for the permission control list 600 from the database 5, parses configuration information of the permission control list 600 and assigns the data of one or more data fields of the data list 601 to the configuration information of the permission control list 600. For example, the parsing module 240 assigns the data of the data fields T1, T3 and T5 to the configuration information, changes the configuration information to “<Company><T1>A-F11111</T1><T3>cb</T3><T5>rb</T5></Company>.”

In step S50, the amendment module 250 amends a status of each GUI widget corresponding to the configuration information.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer, comprising:
at least one processor; and
a storage system that stores one or more programs, when executed by the at least one processor, causing the at least one processor to perform a webpage permission control method, the method comprising:
loading a webpage from a database connected to the computer and obtaining names of graphical user interface (GUI) widgets in the webpage;
searching for a data list from the database and assigning data of a data field of the data list to a GUI widget in the webpage, wherein the data field of the data list corresponds to the GUI widget;
searching for a permission control list from the database and parsing configuration information of the permission control list, wherein the configuration information corresponds to one or more data fields of the data list;
assigning the data of the one or more data fields of the data list to the configuration information of the permission control list; and
amending a status of each GUI widget corresponding to the configuration information.

2. The computer of claim 1, wherein the permission control list comprises a first data field, a second data field, a third data field, and a fourth data field.

3. The computer of claim 2, wherein the first data field of the permission control list is a primary key of the permission control list.

4. The computer of claim 2, wherein the second data field of the permission control list determines an authority of a user who accesses the data list.

5. The computer of claim 2, wherein the third data field of the permission control list comprises a table name of the data list.

6. The computer of claim 2, wherein the fourth data field of the permission control list comprises the configuration information, and the configuration information corresponds to one or more data fields of the data list upon the condition that the configuration information comprises names of the one or more data fields of the data list.

7. The computer of claim 1, wherein each GUI widget comprises a visible status, a written-read status, a read-only status, and an invisible status.

8. A webpage permission control method implemented by a computer, the method comprising:
loading a webpage from a database connected to the computer and obtaining names of graphical user interface (GUI) widgets in the webpage;
searching for a data list from the database and assigning data of a data field of the data list to a GUI widget in the webpage, wherein the data field of the data list corresponds to the GUI widget;
searching for a permission control list from the database and parsing configuration information of the permission control list, wherein the configuration information corresponds to one or more data fields of the data list;
assigning the data of the one or more data fields of the data list to the configuration information of the permission control list;
amending a status of each GUI widget corresponding to the configuration information.

9. The method of claim 8, wherein the permission control list comprises a first data field, a second data field, a third data field, and a fourth data field.

10. The method of claim 9, wherein the first data field of the permission control list is a primary key of the permission control list.

11. The method of claim 9, wherein the second data field of the permission control list determines an authority of a user who accesses the data list.

12. The method of claim 9, wherein the third data field of the permission control list comprises a table name of the data list.

13. The method of claim 9, wherein the fourth data field of the permission control list comprises configuration information, and the configuration information corresponds to one or more data fields of the data list upon the condition that the configuration information comprises names of the one or more data fields of the data list.

14. The method of claim 8, wherein each GUI widget comprises a visible status, a written-read status, a read-only status, and an invisible status.

15. A non-transitory computer-readable medium having stored thereon instructions that, when executed by a computer, causing the computer to perform a webpage permission control method, the method comprising:
loading a webpage from a database connected to the computer and obtaining names of graphical user interface (GUI) widgets in the webpage;
searching for a data list from the database and assigning data of a data field of the data list to a GUI widget in the webpage, wherein the data field of the data list corresponds to the GUI widget;
searching for a permission control list from the database and parsing configuration information of the permission control list, wherein the configuration information corresponds to one or more data fields of the data list;
assigning the data of the one or more data fields of the data list to the configuration information of the permission control list;
amending a status of each GUI widget corresponding to the configuration information.

16. The non-transitory computer-readable medium of claim 15, wherein the permission control list comprises a first data field, a second data field, a third data field, and a fourth data field.

17. The non-transitory computer-readable medium of claim 16, wherein the first data field of the permission control list is a primary key of the permission control list.

18. The non-transitory computer-readable medium of claim 16, wherein the second data field of the permission control list determines an authority of a user who accesses the data list.

19. The non-transitory computer-readable medium of claim 16, wherein the third data field of the permission control list comprises a table name of the data list.

20. The non-transitory computer-readable medium of claim 15, wherein the fourth data field of the permission control list comprises configuration information, and the configuration information corresponds to one or more data fields of the data list upon the condition that the configuration information comprises names of the one or more data fields of the data list.
